(19) United States
(12) Patent Application Publication
(10) Pub. No.: US 2015/0221141 A1
(43) Pub. Date: Aug. 6, 2015

(54) FLIGHT DATA RECORDER WITH WEB ACCESS IN REAL TIME

(71) Applicant: Alfredo Oscar NEGRITTO, San Francisco (AR)

(72) Inventor: Alfredo Oscar NEGRITTO, San Francisco (AR)

(21) Appl. No.: 14/173,228

(22) Filed: Feb. 5, 2014

(51) Int. Cl. G07C 5/00; H04L 29/08

(52) U.S. Cl. CPC G07C 5/008; H04L 67/02

(57) ABSTRACT

Flight data recorder with web access in real time to be used for recording and transmitting via internet in real time all events on-board and control parameters and aircrafts' command, and includes a computer with audio and video inputs respectively referred to microphones and cameras and ARINC interface (Aeronautical Radio Inc.) connected to the aircraft net to obtain information on the flight instruments, so that the information obtained, processed in the flight device formed by the data acquisition unit and cabin interface, is transmitted via internet through an ISP satellite (internet service provider) to the on land data center that feeds a database and provides, through a WEB application service, a front-end of specific access for each client where it can view in real time the information of any of his aircrafts and check the historic information and the application programming interface (API) which enables personalized and direct access for private use.

### FIELD OF THE INVENTION

The invention device is used to control and follow up passengers and cargo aircrafts in real time.

### DESCRIPTION OF RELATED ART

Up to the present time, prior art regarding the aircrafts' date recording is limited to the black box or flight recorder consisting of a device which records the avionics information and the cabin's audio permanently keeping the last track of the recording. It is useful only to analyze an accident's causes once the accident has already occurred and it generally requires a high operative cost and a long time to localize the device or, in case of terrorism events, it is used to conduct investigations after the event has taken place, but it does not give any possibility of placing an alert or preventing the event.

### SUMMARY OF THE INVENTION

This invention refers to a FLIGHT DATA RECORDER WITH WEB ACCESS IN REAL TIME, to be used for recording and transmitting via internet in real time all events on-board and control parameters and aircrafts' command, and includes a computer with audio and video inputs respectively referred to microphones and cameras and ARINC interface (Aeronautical Radio Inc.) connected to the aircraft net to obtain information on the flight instruments, so that the information obtained, processed in the flight device formed by the data acquisition unit and cabin interface, is transmitted via internet through an ISP satellite (internet service provider) to the on land data center that feeds a database and provides, through a WEB application service, a front-end of specific access for each client where it can view in real time the information of any of its aircrafts and check the historic information and the application programming interface (API) which enables personalized and direct access for private use.

The hardware necessary to implement this invention includes two motherboard integrated with the processor with a solid state hard disk; an emergency battery to be used in case of power interruption; an ARINC/ET interface; an ETHERNET SWITCH for the connection of different data-entry devices such as IP cameras and/or IP microphones, a common network to be accessed to by motherboards for data acquisition.

Although the set described is the one that must be necessarily active, the ideal situation is to carry duplicate units to avoid service interruption in case of any hardware or software damage.

As regards software, the operating system to be used is Linux so as to be able to run the service applied to receive information and store it in a local buffer before sending it to avoid any loss of information in case of a temporal connection interruption. Initially, the information is locally stored, and then it is compressed and transferred to the servers.

The compression mechanism adjusts to the bandwidth available, that is to say, the system checks the quality of the connection to be used and compresses the information accordingly. If during the compression process it is necessary to reduce the quality of the information, it will be kept pending and will be sent once the connection quality is recovered to be able to send the whole of the information stored in the device.

### PURPOSE OF THE INVENTION

According to the above mentioned, the main purpose of the invention hereof is to provide a Flight Data Recorder with Web Access in Real Time fit for recording avionics audio, video and information, and sending it in real time to web servers through the internet providing secure access to each company hiring the service. Companies will also be able to view on screen each aircraft authorized by the company on a map and to follow up the machine's route in real time.

A second purpose of the invention hereof is to provide a device with the characteristics of the main purpose, fit for storing historic data to be analyzed at any time and to produce statistical information.

To demonstrate the advantages which have been briefly described and to facilitate the understanding of the structural and functional characteristics of the Flight Data Recorder with Web Access in Real Time here follows a description of a preferred layout of specification schematically presented in the figure sheets attached hereto.

### BRIEF DESCRIPTION OF THE DRAWINGS

FIG. 1 shows the device in the whole circuit.

FIG. 2 shows the two motherboards on-board and their connection with the input devices.

### DETAILED DESCRIPTION

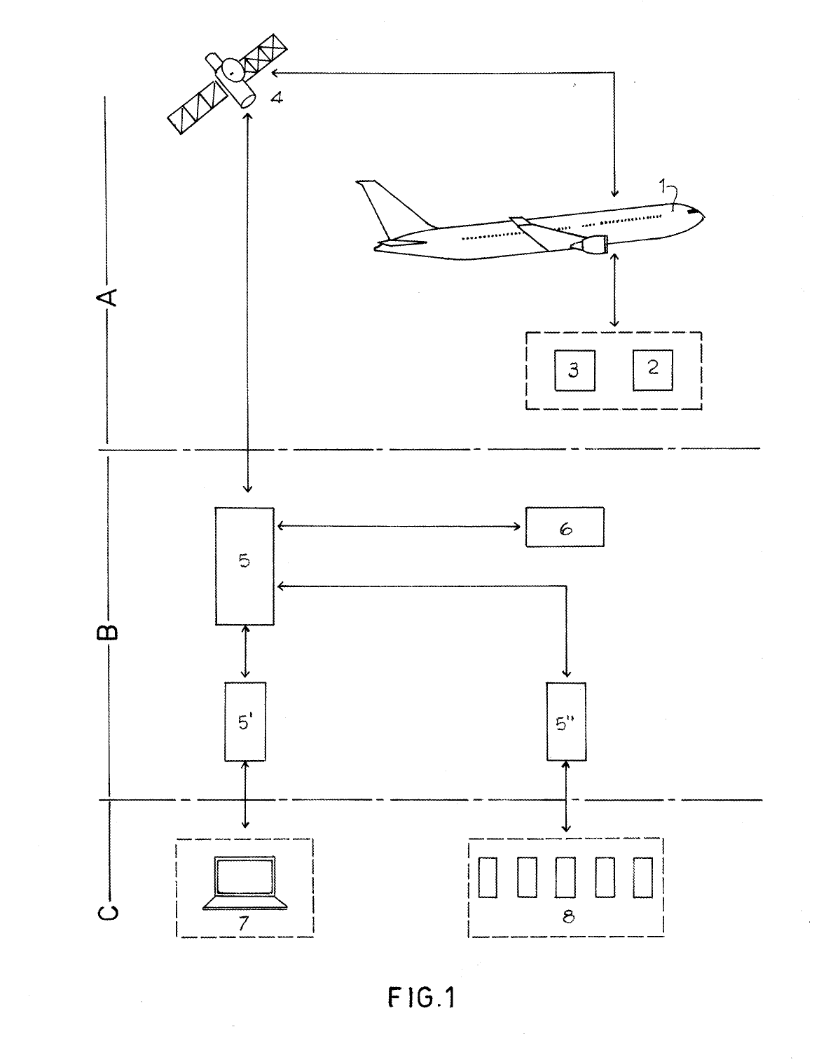

As shown in FIG. 1, the aircraft (1) in flight (field A) has a cabin's interface (2) and a receptor audio unit. Video and avionics (3) transmitted through a satellite (4) by an ISO internet server to a data center with web application service. (5) on land (field B) feeding a data base (6) and transferring them through a web application service. (5′) an interface module (7) (field B) and through an API interface program (5″) to a private and secure application (8) belonging to each client.

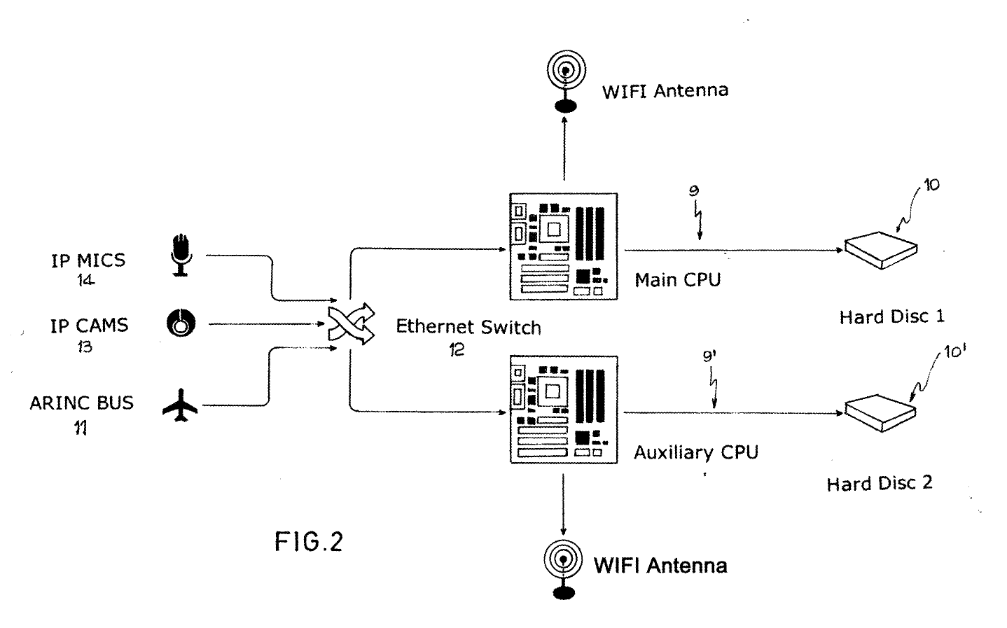

FIG. 2 shows the two motherboards (a major 9) and an auxiliary 9′) with an integrated

processor with a solid- state-hard disk (10) and (10′); an ARINC/ETHERNET interface (11), a SWITCH ETHERNET (12) to allow the connection of different input data-entry devices such as ip cameras (13) and/or ip microphones (14) to a common network.

The referred Flight Data Recorder with Web Access in Real Time is included within the scope of protection of this Invention Patent application, mainly determined by the text of the following claims.

Having described and determined the nature and scope of the invention hereof and the way in which it can be applied, it is hereby declared that the following is claimed as exclusive property right:

What is claimed is:

1. FLIGHT DATA RECORDER WITH WEB ACCESS IN REAL TIME to be used to record and transmit via Internet in real time the on board events and the control and command parameters in aircrafts, comprising microphones and video cameras strategically placed in the aircraft and a ARINC interface connected to the aircraft's net to collect information about the flight's instruments connected to a data acquisition unit and a cabin interface sent via satellite by an ISP internet server to a data center with web application service, on land feeding a data base and transferring them through a web application service, an interface module and through an API interface program to a private and secure application belonging to each client.
